(19) United States
(12) Patent Application Publication
(10) Pub. No.: US 2025/0257809 A1
(43) Pub. Date: Aug. 14, 2025

(54) WATER HEATER DRAIN VALVE

(71) Applicant: NIBCO Inc., Elkhart, IN (US)

(72) Inventor: Christopher W. Mason, Granger, IN (US)

(73) Assignee: NIBCO Inc., Elkhart, IN (US)

(21) Appl. No.: 18/809,411

(22) Filed: Aug. 20, 2024

Related U.S. Application Data
(60) Provisional application No. 63/551,281, filed on Feb. 8, 2024.

(51) Int. Cl. F16K 5/06; F16K 11/087

(52) U.S. Cl. CPC F16K 5/0605; F16K 11/0873

(57) ABSTRACT

A water heater drain valve assembly with T-flow adjustability. The water heater drain valve assembly includes a first valve at the tee in the valve body. The first valve is a 3-way ball valve. A second valve is located on the branch outlet of the valve body. One fitting end of the heater drain valve is elongated in comparison to the other end and the drain port. The elongated fitting end permits the water heater drain valve assembly to be directly coupled to a water heater.

### CLAIM OF PRIORITY

The present application claims the priority benefits under the provisions of 35 U.S.C. § 119, basing said claim of priority on related U.S. Provisional Application No. 63/551,281 filed Feb. 8, 2024, which is incorporated in its entirety herein by reference.

### FIELD OF THE INVENTION

The present invention relates to a water heater drain valve with T-flow adjustability and associated methods.

### BACKGROUND OF THE INVENTION

A drain valve is typically connected to a water heater. The drain valve includes at least one threaded end to permit the coupling of a hose to the water heater to drain the tank for service, replacement, and/or preventative maintenance. Sediment can build up in the bottom of the water heater and/or the drain valve that is connected to the water heater. It can be advantageous to have the ability to add descaling solution to the drain valve and water heater without the descaling solution entering into any associated plumbing. It can also be advantageous to have a branch outlet off of the drain valve to permit access to a secondary appliance or plumbing component.

### SUMMARY OF THE INVENTION

One object of the present invention is a water heater valve. The isolation valve having a tee-shaped valve body having an elongated first fitting end, a second fitting end, and a drain port. The second fitting end is disposed approximately 90° from the first elongated fitting end and the drain port. The drain port is located approximately 180° from the first elongated fitting end. A first valve member with a flow diversion member is located in the fluid passageway of the tee-shaped valve body. The first valve member opens the fluid passageway between the elongated first fitting end and the drain port, while closing the fluid passageway between the second fitting end and both the elongated first fitting end and the drain port when the first valve member is in a first position. The first valve member closes the fluid passageway between the drain port and both of the elongated first fitting end and the second fitting end, while opening the fluid passageway between the elongated first fitting end and the second fitting end when the first valve member is in a second position. The first valve member opens the fluid passageway between the elongated first fitting end and both of the second fitting end and the drain port, when the first valve member is in a third position. The first valve member closes the fluid passageway between the elongated first fitting end and the second fitting end portion and the drain port, while opening the fluid passageway between the second fitting end and the drain port when the first valve member is in a fourth position. A second valve member with a flow diversion member is located between the first valve member and the end of the second fitting end. The elongated first fitting end is longer than both the second fitting end and the drain port.

Another aspect of the present invention is a T-ball valve assembly. The T-ball valve assembly having a tee-shaped valve body having an elongated first fitting end, a second fitting end, and a drain port. The second fitting end is disposed approximately 90° from the elongated first fitting end and the drain port. The drain port is located approximately 180° from the elongated first fitting end. A T-ball valve member is located in the fluid passageway of the tee-shaped valve body. The T-ball valve member opens the fluid passageway between the elongated first fitting end and the drain port, while closing the fluid passageway between the second fitting end and both the elongated first fitting end and the drain port when the T-ball valve member is in a first position. The T-ball valve member closes the fluid passageway between the drain port and both of the elongated first fitting end and the second fitting end, while opening the fluid passageway between the elongated first fitting end and the second fitting end when the T-ball valve member is in a second position. The T-ball valve member opens the fluid passageway between the elongated first fitting end and both of the second fitting end and the drain port, when the T-ball valve member is in a third position. The T-ball valve member closes the fluid passageway between the elongated first fitting end and the second fitting end portion and the drain port, while opening the fluid passageway between the second fitting end and the drain port when the T-ball valve member is in a fourth position. A second valve member with a flow diversion member is located between the first T-ball member and the end of the second fitting end. The elongated first fitting end is longer than both the second fitting end and the drain port. The T-ball valve member has a handle that is shorter than the elongated first fitting end.

Yet another aspect of the present invention is a piping assembly adjacent to a water heater. The piping assembly with a T-ball valve assembly having a tee-shaped valve body having an elongated first fitting end, a second fitting end, and a drain port. The second fitting end is disposed approximately 90° from the elongated first fitting end and the drain port. The drain port is located approximately 180° from the elongated first fitting end. A T-ball valve member is located in the fluid passageway of the tee-shaped valve body. The T-ball valve member opens the fluid passageway between the elongated first fitting end and the drain port, while closing the fluid passageway between the second fitting end and both the elongated first fitting end and the drain port when the T-ball valve member is in a first position. The T-ball valve member closes the fluid passageway between the drain port and both of the elongated first fitting end and the second fitting end, while opening the fluid passageway between the elongated first fitting end and the second fitting end when the T-ball valve member is in a second position. The T-ball valve member opens the fluid passageway between the elongated first fitting end and both of the second fitting end and the drain port, when the T-ball valve member is in a third position. The T-ball valve member closes the fluid passageway between the elongated first fitting end and the second fitting end portion and the drain port, while opening the fluid passageway between the second fitting end and the drain port when the T-ball valve member is in a fourth position. A second valve member with a flow diversion member located between the first T-ball member and the end of the second fitting end. The elongated first fitting end is longer than both the second fitting end and the drain port. The elongated first fitting end is coupled to a water heater. A pipe is coupled to the second fitting end.

These and other advantages of the invention will be further understood and appreciated by those skilled in the art by reference to the following written specification, claims, and appended drawings.

### BRIEF DESCRIPTION OF THE DRAWINGS

In the drawings:

FIG. 1 is a front view of one embodiment of the water heater drain valve showing two different positions of the valve handle;

FIG. 1A is a front view of the embodiment of the water heater drain valve shown in FIG. 1 with the first valve member rotated 180°, showing two different positions of the valve handle;

FIG. 2 is a cross-sectional view of one fitting that can be coupled to the water heater drain valve shown in FIG. 1;

FIG. 3 is a cross-sectional view of the fitting shown in FIG. 2 with a check valve insert permitting flow in one direction;

FIG. 4 is a cross-sectional view of the fitting shown in FIG. 2 with a check valve insert configured to provide flow in the opposite direction;

FIG. 5 is a side view of the fitting shown in FIG. 2;

FIG. 6 is a front perspective view of the fitting shown in FIG. 2;

FIG. 7 is a top perspective view of the check valve insert shown in FIGS. 3 and 4;

FIG. 8 is a side view of the check valve insert shown in FIGS. 3 and 4; and

FIG. 9 is a front perspective view of exemplary fitting ends that can be used on the water heater drain valve.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The detailed embodiments of the present invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representative basis for teaching one skilled in the art to variously employ the present invention and virtually in an appropriately detailed embodiment.

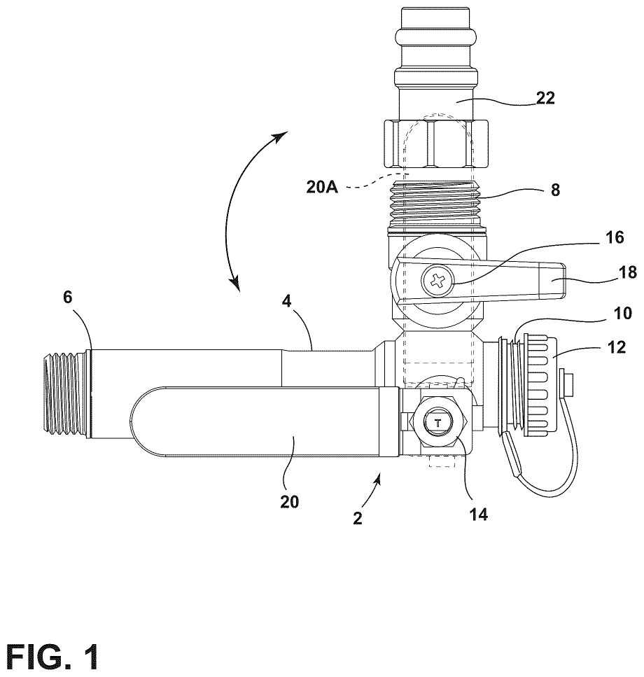

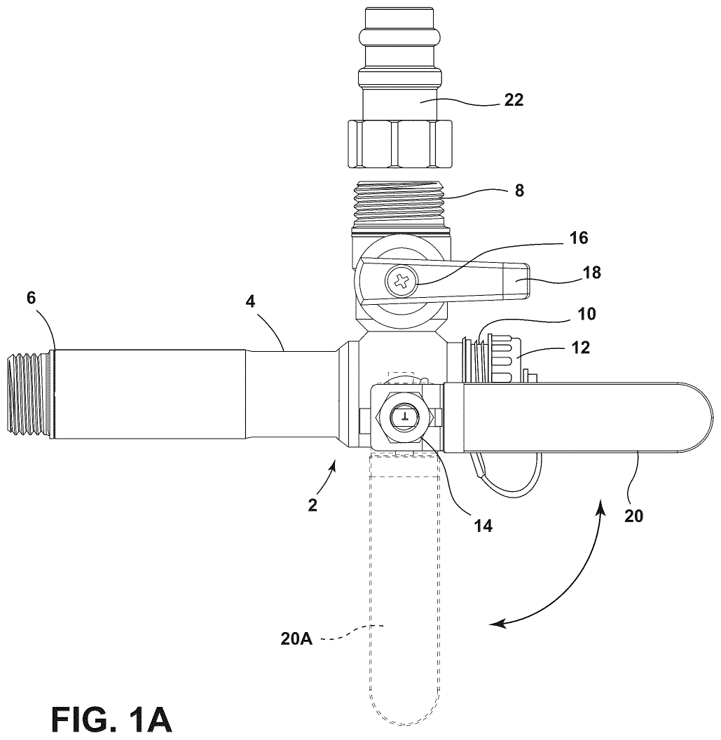

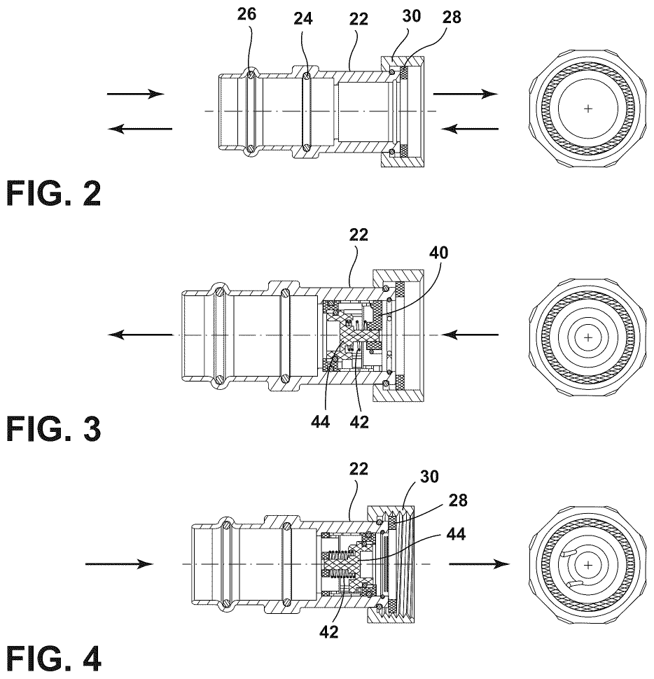

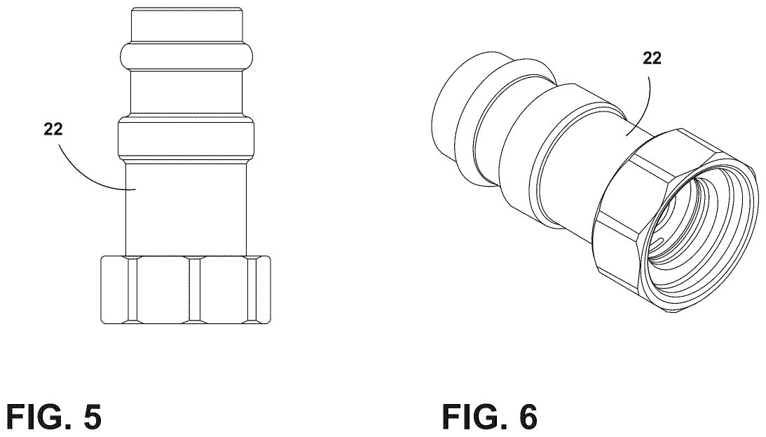

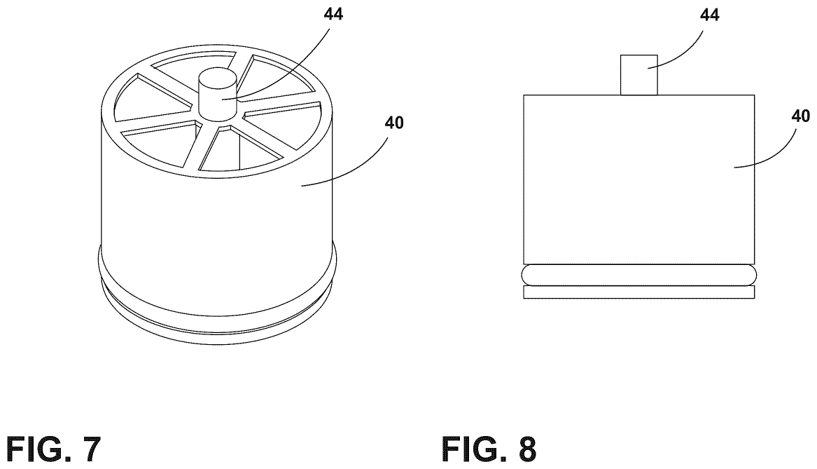

A water heater drain valve assembly 2 is shown in FIGS. 1 and 1A. The water heater drain valve assembly 2 includes a tee-shaped valve body 4. The tee-shaped valve body 4 has a first fitting end 6, a second fitting end 8, and a drain port 10. The first fitting end 6 is elongated, as illustrated in FIGS. 1 and 1A. The elongated first fitting end 6 is thus longer than the second fitting end 8 and the drain port 10 and can be longer than the handle 20 of the first valve member 14, as illustrated in FIGS. 1 and 1A.

A first valve member 14 is positioned at the tee in the valve body 4. Given that the first valve member 14 is positioned at the intersection of the first elongated fitting end 6, second fitting end 8, and drain port 10, the first valve member 14 can open and close the different fluid passageway between these sections of the valve body 4. The first valve member 14 includes a flow diversion member positioned in the fluid passageway. In the illustrated embodiment, the flow diversion member has three openings and is a T-ball valve. The first valve member 14 includes a stem with a symbol on it indicating the position of the openings of the flow diversion member. Thus, as illustrated in FIGS. 1 and 1A, the symbol is a T shown where each of the three openings are aligned. The first valve member 14 can be actuated using the handle 20.

The drain valve member 2 includes a second valve member 16 that is positioned between the first valve member 14 and the end of the second fitting end 8. The second valve member 16 can be actuated using handle 18. The second valve member 16 can also be a T valve member so that the handle 18 can be moved into different orientations.

FIG. 1 illustrates two different positions of the first valve member 14. The first position is shown with the handle 20. In the first position, the first valve member 14 opens the fluid passageway between the elongated first fitting end 6 and the drain port 10, while closing the fluid passageway between the second fitting end 8 and both the elongated first fitting end 6 and the drain port 12. When the first valve member 14 is in a second position, illustrated by handle 20A in FIG. 1, the first valve member 14 closes the fluid passageway between the drain port 10 and the elongated first fitting end 6 and the second fitting end 8, while opening the fluid passageway between the elongated first fitting end 6 and the second fitting end 8. When the first valve member 14 is in a third position, as shown by handle 20 in FIG. 1A, the fluid passageway is opened between the elongated first fitting end 6, the second fitting end 8, and the drain port 10. When the first valve member 14 is in a fourth position, illustrated by handle 20A in FIG. 1A, the fluid passageway is closed between the elongated first fitting end 6 and the second fitting end 8 and drain port 10. When the first valve member 14 is in the fourth position, the fluid passageway is open between the second fitting end 8 and the drain port 10.

The handle 20 of the first valve member 14 can be removed and oriented in a different direction. Handle 20 in FIG. 1 rotates 90° between being positioned over the elongated first fitting end 6 and the second fitting end 8. When the handle 20 has been removed and recoupled, as shown in FIG. 1A, the handle 20 can be moved from over the drain port 10 to being perpendicular to the second fitting end 8. Stops may be positioned on the valve body 4 to permit the handle 20 rotation to only go 90°, as illustrated in FIGS. 1 and 1A.

In the illustrated embodiment, the drain port 10 can have a threaded surface and be covered by a cap 12, as illustrated in FIGS. 1 and 1A. The second fitting end 8 can include a coupling member 22, as illustrated in FIGS. 1 and 1A. The coupling member 22 can include a union 30 to couple to the threaded surface of the second fitting end 8. In the illustrated embodiment, the coupling member 22 is a press-fit coupling with O-rings 24, 26 and a seal member 28.

A check valve insert 40 (FIGS. 3 and 4) may be used to help prevent backflow. The check valve inserts 40 are removable and reversible, allowing for flow path configurability as shown in FIGS. 3 and 4. For example, the coupling member 22 could include a check valve insert 40 positioned as shown in FIG. 3 to prevent backflow into the water heater drain valve assembly 2. The coupling member 22 could include a check valve insert 40, as shown in FIG. 4, to prevent backflow from the water heater drain valve assembly 2 to the components coupled to the second fitting end 8. This could prevent backflow to a secondary appliance or a source of descaling solution. The check valve insert 40 includes a spring member 42 and a diaphragm 44. The diaphragm 44 flexes open when the pressure on the upside is greater than the pressure on the downside and closes when the pressure is equalized or lowered due to the presence of the spring member 42.

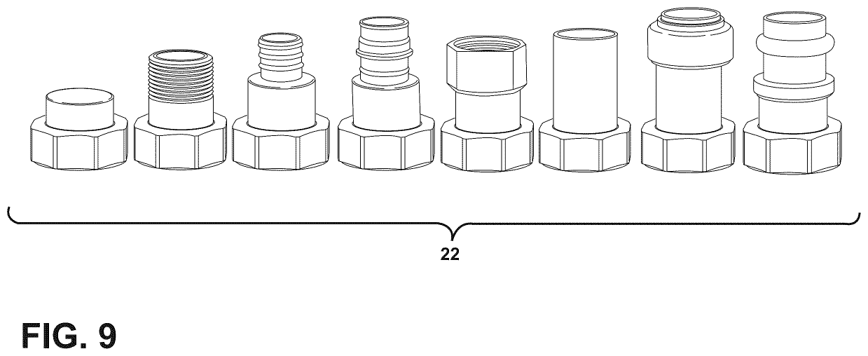

As illustrated in FIG. 9, a variety of coupling members can be used for coupling member 22. While the embodiment shown in FIG. 1 shows the coupling member 22 being a press coupling, any type of coupling member can be used, including those shown in FIG. 9 which, from left to right, are hose-end cap, male iron pipe, PEX, PEX female iron pipe, sweat, push-to-connect, and press fittings.

The elongated first fitting end 6 is shown without a coupling member 22 permitting the elongated first fitting end 6 to be coupled directly to the water heater. Specifically, the elongated first fitting end 6 can be coupled to the drain port of the water heater. The water heater could include a tank or be a tankless water heater. If the elongated first fitting end 6 is not coupled directly to the water heater, a coupling member 22 may be used in between the water heater drain valve 2 and the water heater.

The second fitting end 8 can be coupled to a pipe, to a secondary appliance such as a hot water recirculation pump, or to a drain outlet. The second fitting end 8 can also be used to supply descaling solution to the water heater. The descaling solution could also be introduced to the water heater drain valve 2 through the drain port 10.

In the foregoing description, it will be readily appreciated by those skilled in the art that modifications may be made to the invention without departing from the concepts disclosed herein. Such modifications are to be considered as included in the following claims, unless these claims by their language expressly state otherwise.

It will be understood by one having ordinary skill in the art that construction of the present disclosure and other components is not limited to any specific material. Other exemplary embodiments of the disclosure disclosed herein may be formed from a wide variety of materials, unless described otherwise herein.

For purposes of this disclosure, the term “coupled” or “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “connected” or “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that, unless otherwise described, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating positions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A water heater valve, comprising:
a tee-shaped valve body having an elongated first fitting end, a second fitting end, and a drain port, wherein said second fitting end is disposed approximately 90° from said elongated first fitting end and said drain port, and said drain port is located approximately 180° from said elongated first fitting end;
a first valve member with a flow diversion member located in the fluid passageway of said tee-shaped valve body;
wherein said first valve member opens said fluid passageway between said elongated first fitting end and said drain port, while closing the fluid passageway between said second fitting end and both said elongated first fitting end and said drain port when said first valve member is in a first position;
wherein said first valve member closes said fluid passageway between said drain port and both of said elongated first fitting end and said second fitting end, while opening the fluid passageway between said elongated first fitting end and said second fitting end when said first valve member is in a second position;
wherein said first valve member opens said fluid passageway between said elongated first fitting end and both of said second fitting end and said drain port, when said first valve member is in a third position;
wherein said first valve member closes said fluid passageway between said elongated first fitting end and said second fitting end portion and said drain port, while opening the fluid passageway between said second fitting end and said drain port when said first valve member is in a fourth position;
a second valve member with a flow diversion member located between said first valve member and the end of said second fitting end; and
wherein said elongated first fitting end is longer than both said second fitting end and said drain port.

2. The water heater valve of claim 1, wherein said first valve member includes a stem with a symbol showing the alignment of the openings in the flow diversion member.

3. The water heater valve of claim 1, wherein said first valve member includes an elongated handle.

4. The water heater valve of claim 1, wherein said tee-shaped valve body is a unitary piece.

5. The water heater valve of claim 1, wherein said first fitting end and said second fitting end are the same type of fitting.

6. The water heater valve of claim 1, wherein said tee-shaped valve body is made from a material that includes brass.

7. The water heater valve of claim 1, wherein said second valve member is a ball valve.

8. A T-ball valve assembly, comprising:
a tee-shaped valve body having an elongated first fitting end, a second fitting end, and a drain port, wherein said second fitting end is disposed approximately 90° from said elongated first fitting end and said drain port, and said drain port is located approximately 180° from said elongated first fitting end;
a T-ball valve member with a flow diversion member located in the fluid passageway of said tee-shaped valve body;
wherein said T-ball valve member opens said fluid passageway between said elongated first fitting end and said drain port, while closing the fluid passageway between said second fitting end and both said elongated first fitting end and said drain port when said T-ball valve member is in a first position;
wherein said T-ball valve member closes said fluid passageway between said drain port and both of said elongated first fitting end and said second fitting end, while opening the fluid passageway between said elongated first fitting end and said second fitting end when said T-ball valve member is in a second position;
wherein said T-ball valve member opens said fluid passageway between said elongated first fitting end and both of said second fitting end and said drain port, when said T-ball valve member is in a third position;
wherein said T-ball valve member closes said fluid passageway between said elongated first fitting end and said second fitting end portion and said drain port, while opening the fluid passageway between said second fitting end and said drain port when said T-ball valve member is in a fourth position;
a second valve member with a flow diversion member located between said first T-ball member and the end of said second fitting end;
wherein said elongated first fitting end is longer than both said second fitting end and said drain port; and
wherein said T-ball valve member has a handle that is shorter than said elongated first fitting end.

9. The T-ball valve assembly of claim 8, wherein said first valve member includes a stem with a symbol showing the alignment of the openings in the flow diversion member.

10. The T-ball valve assembly of claim 8, wherein said first valve member includes an elongated handle.

11. The T-ball valve assembly of claim 8, wherein said tee-shaped valve body is a unitary piece.

12. The T-ball valve assembly of claim 8, including a union fitting coupled to said second fitting end.

13. A piping assembly adjacent to a water heater, comprising:
a tee-shaped valve body having an elongated first fitting end, a second fitting end, and a drain port, wherein said second fitting end is disposed approximately 90° from said elongated first fitting end and said drain port, and said drain port is located approximately 180° from said elongated first fitting end;
a T-ball valve member with a flow diversion member located in the fluid passageway of said tee-shaped valve body;
wherein said T-ball valve member opens said fluid passageway between said elongated first fitting end and said drain port, while closing the fluid passageway between said second fitting end and both said elongated first fitting end and said drain port when said T-ball valve member is in a first position;
wherein said T-ball valve member closes said fluid passageway between said drain port and both of said elongated first fitting end and said second fitting end, while opening the fluid passageway between said elongated first fitting end and said second fitting end when said T-ball valve member is in a second position;
wherein said T-ball valve member opens said fluid passageway between said elongated first fitting end and both of said second fitting end and said drain port, when said T-ball valve member is in a third position;
wherein said T-ball valve member closes said fluid passageway between said elongated first fitting end and said second fitting end portion and said drain port, while opening the fluid passageway between said second fitting end and said drain port when said T-ball valve member is in a fourth position;
a second valve member with a flow diversion member located between said first T-ball member and the end of said second fitting end;
wherein said elongated first fitting end is longer than both said second fitting end and said drain port;
wherein said elongated first fitting end is coupled to a water heater; and
a pipe is coupled to said second fitting end.

14. The piping assembly of claim 13 wherein said tee-shaped valve body is a unitary piece.

15. The piping assembly of claim 13 wherein said tee-shaped valve body is made from a material including brass.

16. The piping assembly of claim 13 wherein said first fitting end is directly coupled to the drain ort of a storage tank of said water heater.

17. The piping assembly of claim 13 including a union fitting coupled to said second fitting end.

18. The piping assembly of claim 17 wherein said union fitting includes a check valve insert.

19. The piping assembly of claim 13 wherein said T-ball valve member has a handle and wherein the length of said elongated first fitting end is longer than the length of said handle.

20. The piping assembly of claim 13 wherein said drain port includes external threading.
